(19) United States
(12) Patent Application Publication
(10) Pub. No.: US 2016/0078115 A1
(43) Pub. Date: Mar. 17, 2016

(54) Interactive System and Method for Processing On-Screen Items of Textual Interest

(71) Applicant: Breach Intelligence LLC, Farmington, CT (US)

(72) Inventor: Paul A. Battista, JR., Farmington, CT (US)

(21) Appl. No.: 14/487,790

(22) Filed: Sep. 16, 2014

(51) Int. Cl. G06F 17/30; G06F 17/24; G06K 9/72; G06K 9/62; G06K 9/80

(52) U.S. Cl. CPC G06F 17/30572; G06K 9/6202; G06K 9/80; G06K 9/72; G06F 17/243

(57) ABSTRACT

A computer-implemented method processes information displayed on a computer display by alerting, tagging and/or overlaying information about content of textual interest to a user. The alerting function detects items believed to be interest to the user, and notifies the user of the existence of that item and provides the user with an opportunity to tag the item. The tagging function allows the user to highlight information on the display and open a window to tag an item of interest. The overlaying function presents additional information about an item of interest selected by the user. The various functions operate independent of the application presenting the information on the display.

### FIELD OF THE DISCLOSURE

Aspects of the disclosure relate to an application-independent software tool to help alert, tag and provide information about content of interest to a viewer of a computer screen.

### BACKGROUND

In certain settings, a viewer of a computer screen may wish to understand information displayed containing specific items of interest, such as specific words, specific strings of alphanumeric characters and other typographic symbols. In general, such viewers manually search necessary external sources for specific strings of displayable characters following a predetermined structural format. For example, a network analyst might be working with data on a computer screen using multiple software applications, unaware of a specific item of textual interest, such as a malicious IP address, email address, domain name, file hash or the like, present on the screen. Such an analyst would need to manually search for or look-up each IP address, email address, domain name, or file hash in external sources to determine if it is known to be malicious, and hence a specific item of interest. Additionally, in all such instances, when the computer screen is cluttered it may become difficult for the viewer to discern items of textual interest, which may be buried in all the “noise”. This can occur whether the screen is scrolling rapidly with new content appearing on the screen and older content disappearing, the screen is not scrolling but rapid updates randomly appear in multiple locations on the screen, and also when the entire screen is replaced with a new screen in rapid succession.

What is desired is a software utility that alerts a viewer when specific items of textual interest appear on the screen. Such a utility would ideally operate independent of the underlying application presenting content on the screen. It would also be beneficial if such a utility would permit the user to add new specific items of textual interest for which alerts would also be thereafter provided.

### SUMMARY

In one aspect, the present invention is directed to a system configured to alert a viewer of a computer screen to an on-screen presence of a specific item of textual interest comprising a consecutive string of displayable characters having a predetermined structural format. The system comprises an alerting function which, without viewer intervention, is configured to:
(a) capture an image of at least a portion of the computer screen;
(b) perform character recognition on the captured image to obtain at least one extracted entity comprising a consecutive string of displayable characters following the predetermined structural format;
(c) compare the at least one extracted entity with a knowledge base comprising at least one known item of textual interest to find if there is a match; and
(d) indicate on the computer screen at least one matched known item of textual interest, to thereby alert the viewer that said at least one known item of textual interest currently appears on the computer screen

The system may further comprise a tagging function invoked by a viewer after copying a portion of selected text to a temporary memory, the tagging function configured to:
open a form on the computer screen in response to viewer action, the form having at least one field;
display at least a portion of the selected text so as to be associated with the form;
receive into the field, at least one tag entered by the viewer as being associated with the at least a portion of the selected text; and
add the at least a portion of the selected text as another known item of textual interest for future comparison by the alerting function.

The system may additionally comprise an overlay function which, when enabled by a viewer, is configured to:
capture an image of at least a portion of the computer screen;
perform character recognition on the captured image to obtain at least one extracted overlay entity;
indicate said at least one extracted overlay entity on the computer screen; and
in response to viewer action selecting one of such indicated extracted overlay entities, display information about the selected one of such indicated extracted overlay entities on the computer screen.

In another aspect, the present invention is directed to a method of alerting a viewer of a computer screen to an on-screen presence of a specific item of textual interest comprising a consecutive string of displayable characters having a predetermined structural format. The method comprises:
(a) capturing an image of at least a portion of the computer screen;
(b) performing character recognition on the captured image to obtain at least one extracted entity comprising a consecutive string of displayable characters following the predetermined structural format;
(c) comparing the at least one extracted entity with a knowledge base comprising at least one known item of textual interest to find if there is a match; and
(d) indicating on the computer screen at least one matched known item of textual interest, to thereby alert the viewer that said at least one known item of textual interest currently appears on the computer screen.

In yet another aspect, the present invention is directed to a method of providing additional information about an item currently being displayed on a computer screen to a viewer, the method comprising:
(a) capturing an image of at least a portion of the computer screen;
(b) performing character recognition on the captured image to obtain at least one extracted overlay entity comprising a consecutive string of displayable characters following a predetermined structural format;
(c) indicating said at least one extracted overlay entity on the computer screen; and
(d) in response to viewer action selecting one of such indicated extracted overlay entities, displaying information about the selected one of such indicated extracted overlay entities on the computer screen.

A system configured to implement the above-mentioned method of providing additional information is also contemplated

In still another aspect, the present invention is directed to a method of processing information being displayed on a computer screen to a viewer, the method comprising:
(a) capturing an image of at least a portion of the computer screen;
(b) performing character recognition on the captured image to obtain at least one extracted entity comprising a consecutive string of displayable characters following a predetermined structural format;
(c) without viewer intervention:
   (c1) comparing the at least one extracted entity with a knowledge base comprising at least one known item of textual interest to find if there is a match; and
   (c2) indicating on the computer screen at least one matched known item of textual interest, to thereby alert the viewer that said at least one known item of textual interest currently appears on the computer screen; and
(d) in response to a viewer copying a portion of selected text to a temporary memory:
   (d1) opening a form on the computer screen in response to further viewer action, the form having at least one field;
   (d2) displaying at least a portion of the selected text so as to be associated with the form;
   (d3) receiving into the field, at least one tag entered by the viewer as being associated with the at least a portion of the selected text; and
   (d4) adding the at least a portion of the selected text as another known item of textual interest for use in a future comparing step.

When enabled by the viewer, this aspect of the invention may further comprise:
(e1) performing character recognition on the captured image to obtain at least one extracted overlay entity comprising said consecutive string of displayable characters following a predetermined structural format;
(e2) indicating said at least one extracted overlay entity on the computer screen; and
(e3) in response to further viewer action, selecting one of such indicated extracted overlay entities, displaying information about the selected one of such indicated extracted overlay entities on the computer screen.

A system configured to implement the above-mentioned methods of processing information being displayed on a computer screen is also contemplated.

In a further aspect, the present invention is directed to a method of processing information being displayed on a computer screen to a viewer, the method comprising:
(a) capturing an image of at least a portion of the computer screen;
(b) performing character recognition on the captured image to obtain at least one extracted entity comprising a consecutive string of displayable characters following a predetermined structural format;
(c) without viewer intervention:
   (c1) comparing the at least one extracted entity with a knowledge base comprising at least one known item of textual interest to find if there is a match; and
   (c2) indicating on the computer screen at least one matched known item of textual interest, to thereby alert the viewer that said at least one known item of textual interest currently appears on the computer screen; and
(c) when enabled by the viewer:
   (d1) performing character recognition on the captured image to obtain at least one extracted overlay entity comprising said consecutive string of displayable characters following a predetermined structural format;
   (d2) indicating said at least one extracted overlay entity on the computer screen; and
   (d3) in response to further viewer action, selecting one of such indicated extracted overlay entities, displaying information about the selected one of such indicated extracted overlay entities on the computer screen.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

The present disclosure is explained with reference to the following figures, in which:

FIG. 1 shows an alerting system for alerting a user of a computer screen of the existence of an item of textual interest currently being displayed.

FIG. 2 shows a flowchart depicting one embodiment of the alerting process.

FIG. 3 shows an exemplary screen shot from a first software application in which the user is notified of a first item of textual interest.

FIG. 4 shows a screen shot after scrolling the screen shot of FIG. 3 a few lines, resulting in the user being alerted to a second item of textual interest in addition to the first item of textual interest.

FIG. 5 shows a flowchart depicting one embodiment of a recognition methodology for recognizing on-screen text.

FIG. 6 shows a tagging system for enabling a user to tag an item on the screen being viewed.

FIG. 7 shows a flowchart depicting one embodiment of the tagging process.

FIG. 8 shows an exemplary screen shot from a second software application in which the user has executed a first key combination to select an item and is prompted to tag the selected item.

FIG. 9 shows a screen shot of a basic tagging window.

FIG. 10 shows a screen shot of an advanced tagging window.

FIG. 11 shows a screen shot similar to FIG. 8, but after the user has tagged the selected item and is notified of two items of textual interest.

FIG. 12 shows a screen shot after scrolling the screen shot of FIG. 11 a few lines, resulting in the user being alerted to an additional (third) item of textual interest.

FIG. 13 shows an overlay system for providing additional data to a user about information of interest on a current computer screen.

FIG. 14 shows a flowchart depicting one embodiment of the overlay process.

FIG. 15 shows an exemplary screen shot from a first software application provided with a first embodiment of an overlay display.

FIG. 16 shows an exemplary screen shot from a first software application provided with a second embodiment of an overlay display.

FIG. 17 shows an exemplary screen shot from a second software application provided with a first embodiment of an overlay display.

### DETAILED DESCRIPTION

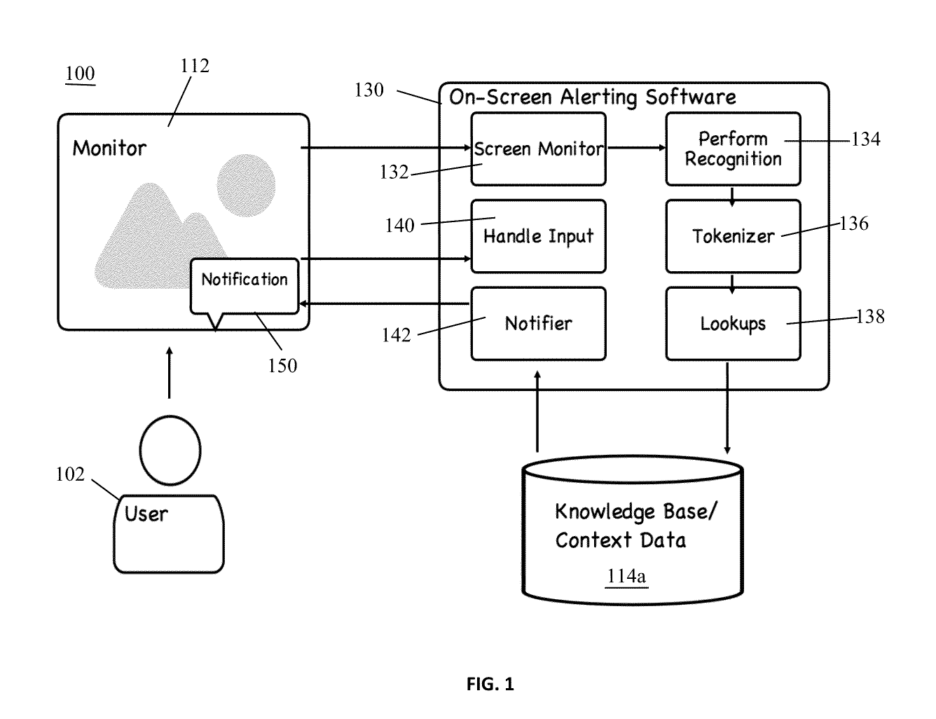

FIG. 1 shows one embodiment of an alerting system 100 in accordance with the subject matter of the present application. The alerting system alerts a viewer (“user”) of a computer screen of the existence of an item of textual interest currently being displayed. Generally speaking, the alerting function runs in the background of the user's computer, automatically notifying the user of information that is relevant.

When the alerting function is activated, the user 102 interacts with the computer monitor (screen) 112 while on-screen alerting software 130 runs in the background. The on-screen alerting software 130 comprises a number of software components shown generally as 132-142.

The image displayed on the monitor 112 is captured by a screen monitor component 132, which grabs the image data being displayed on the screen from a memory. In one embodiment, a bit-block transfer of the data from the screen is executed using an operating system call. This, at least temporarily, places the image in another memory which can then be analyzed with character recognition utilities, and the like, to ascertain the textual content that was on-screen.

The perform recognition component 134 looks for changes on the screen 112 and prepares images for further processing, by recognizing, e.g., textual characters, and creating a first record comprising textual characters and their associated locations on the screen 112. It is understood that the textual characters comprise not only alphanumeric characters, but also non-alphanumeric characters such as periods, commas, and other symbols.

The tokenizer component 136 receives the output of the perform recognition component 134 and searches for predetermined patterns (templates) of data to detect potential items of interest (“tokens”) to the user. If the perform recognition component 134 outputs a first record comprising textual characters, the potential items of interest searched for by the tokenizer component 136 comprise strings of textual characters having perhaps a predetermined format. Generally speaking the tokenizer component 136 is configured to search for and extract different predetermined patterns of data that are relevant to the user's industry. For example, in the infosec industry, the tokenizer component 136 might search for and extract patterns of text representing IP addresses or domain names, since such items would be of interest to, say, a network analyst. And in the financial industry, the tokenizer component 136 might search for specific stock symbols, perhaps in combination with transaction volumes and/or stock prices, which would be of interest to, say, a trader. The tokenizer component 136 creates a second record comprising potential items of interest, such as IP addresses and/or domain names in the case of the infosec industry, and stock symbols and their associated transaction volumes and stock prices in the case of the financial industry. Henceforth, each of these potential items of interest may also be referred to as an “extracted entity”

Of all the extracted entities detected by the tokenizer component 136 in this second record, only a subset, if any, may actually be of an item of textual interest to the user 102. A lookups component 138 compares the extracted entities detected by the tokenizer component 136 with known items of textual interest stored in an appropriate knowledge base 114a to see whether the detected tokens (e.g., IP addresses, domain names, stock symbols, etc.) match specific values which have been previously stored in the knowledge base 114a, and have been marked as being an item of textual interest to the user in question.

In some embodiments, the knowledge base 114a is not dedicated to the user's computer, but instead is a shared resource. In such embodiments, the knowledge base 114a may reside on a local area network, a wide area network, in the cloud or the like. In other embodiments, however, the knowledge base 114a may be dedicated to the user's computer. In either scenario, the contents of the knowledge base 114a may be modified from time to time, as the known items of textual interest change. Also, modifications to contents of the knowledge base 114a may be done by someone other than a given user.

If the lookups component 138 finds any matches, a third record comprises matched items is formed, and then a notifier component 142 formats and outputs a notification 150 to the screen 112, alerting the user to such matched items. The result is that the user 112 is alerted that something known to be an item of textual interest to that user is currently on the screen 112, and potentially warrants attention.

A handler input component 140 then monitors any action of the user, such as use of an input device (e.g., keyboard, mouse, voice commands, gesture, etc.) to detect whether the user 102 has interacted with either the notification 150, or the screen content resulting in the notification, for further processing. The handle input component 140 may then perform predetermined actions such as opening a window displaying additional details or even a web page associated with the matched item, or even closing the notification 150, depending on user input.

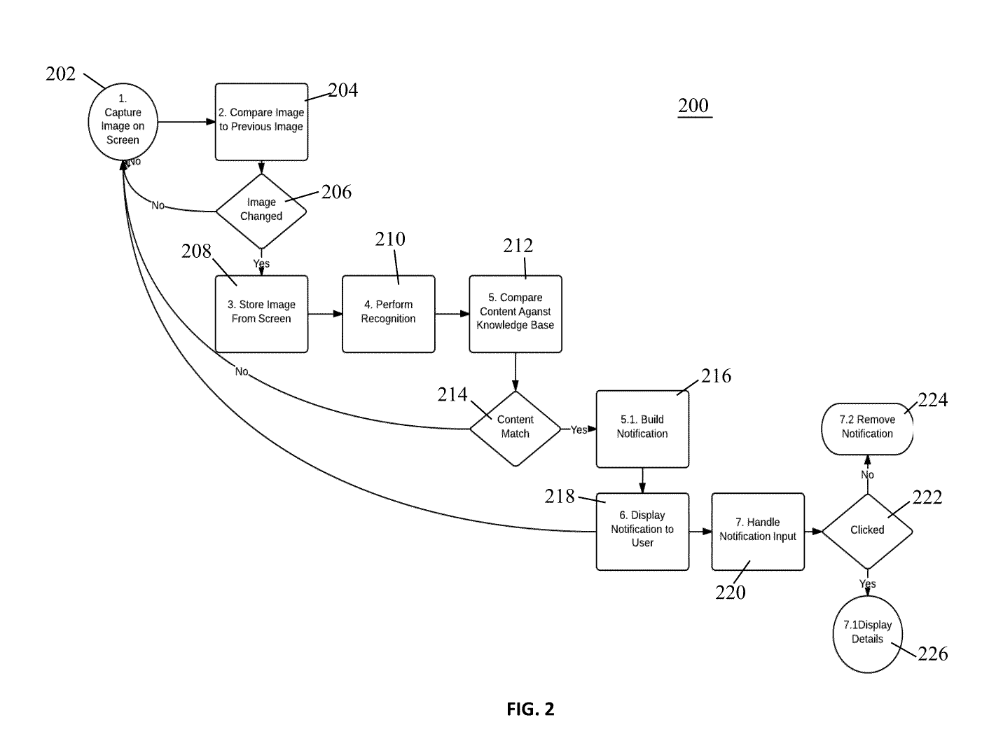

FIG. 2 shows a flow chart 200 presenting the alerting process.

In step 202, the image on the screen 112 is captured by the screen monitor component 132 and in step 204 the captured image is compared with a previous image. In step 206, a determination is made as to whether there has been a change in the image. If there is no change, the image on the screen 112 is captured once again 202 and the loop is repeated. If, on the other hand, there has been a change, the image on the screen 112 is stored in step 208 and in step 210, the perform recognition component 134 and the tokenizer component 136 detect extracted entities. Then, in step 212, the lookups component 138 compares the extracted entities with the known items of textual interest in the knowledge base 114a and a decision is made in step 214 as to whether there is a match.

If, in step 214, there is no match between the extracted entities and the known items of textual interest in the knowledge base 114a, a new image is captured 212 and the process continues. If, on the other hand, in step 214, there is a match between the extracted entities and the known items of textual interest in the knowledge base 114a, a record of the matched items is created. Then, in step 216, the notifier component 142 builds a notification 150 and in step 218 the notification 150 is displayed on the screen 112. Thereafter, in step 220, the handler input component 140 looks for user input. In step 222, any such user input is processed. The result of the user input may be to remove the notification 150 (step 224) or display additional information (step 226), depending on the user's action.

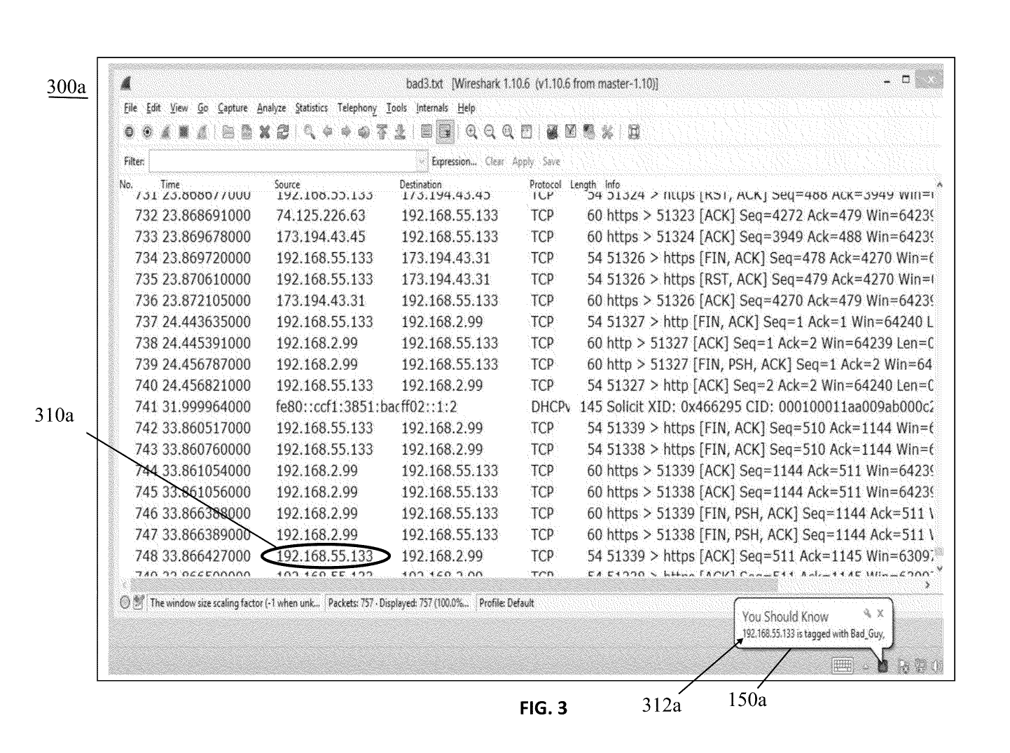

FIG. 3 shows a first exemplary screen shot 300a from a first software application (“Wireshark”) in which the user is notified of a first IP address of interest 310a. In this instance, the first IP address of interest 310a on the screen is “192.168.55.133” and this has been matched with a corresponding known item of textual interest in the knowledge base 114a. As a consequence of this match, a notification 150a is displayed in the screen shot 300a containing a notification entry 312a. The notification entry 312a may comprise the matched IP address “192.168.55.133” along with information about the matched IP address. In this instance, the information presented to the user 102 is that the matched IP address “is tagged with Bad_Guy”. Thus, notification 150a informs the user that a known item of textual interest (i.e., the matched IP address) is currently on the screen 112, and also presents some information retrieved from the knowledge based 114a about that IP address. In this instance, the information presented serves to remind the user why the IP address may have been of interest in the first instance (i.e., it is associated with “Bad_Guy”).

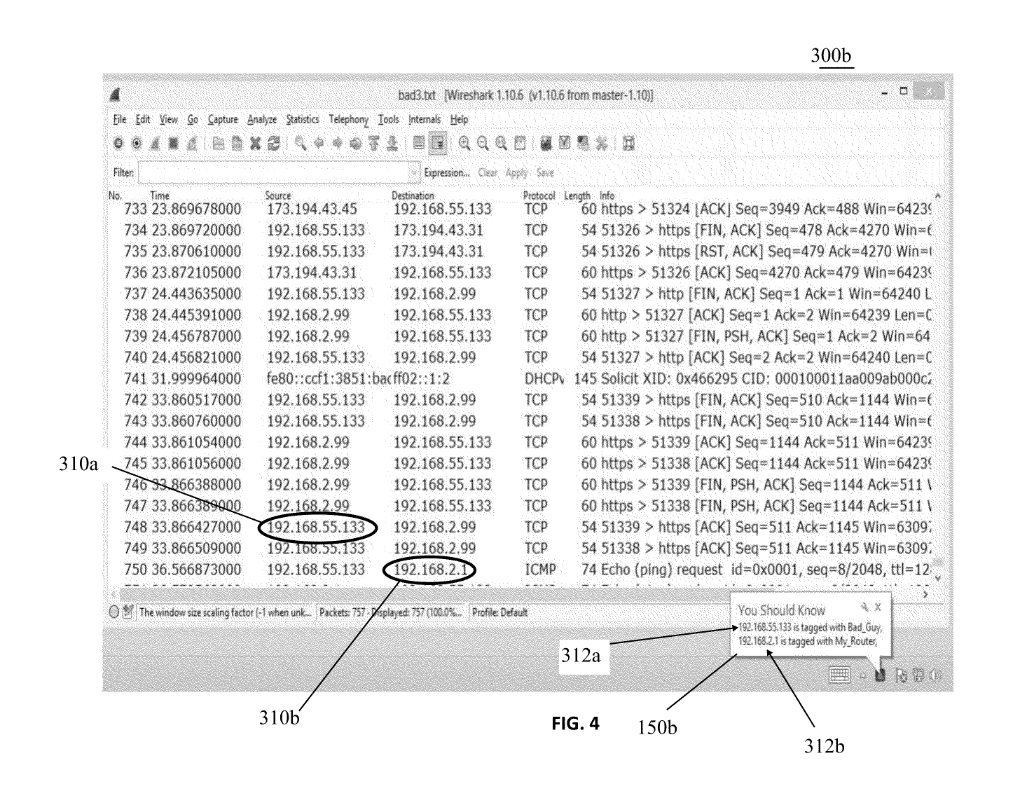

FIG. 4 shows a second exemplary screen shot 300b, which shows the first exemplary screen shot 300a of FIG. 3 after a scrolling up by two lines. In the second screen shot 300b, a new IP address 310b (“192.168.2.1”) appears and the system 100 has matched this IP address as also being a known item of textual interest. Since the earlier item of textual interest 310a also appears on screenshot 300b, the notification 150b now comprises two notification entries 312a, 312b, each corresponding to one of the IP addresses of interest 310a, 310b, respectively. In this instance, previous notification entry 312a again indicates that the corresponding IP address “is tagged with Bad_Guy”, while new notification entry 312b indicates that the corresponding new IP address “is tagged with My_Router”. In this manner, the user 102 is alerted to the fact that two known items of textual interest concurrently appear on the screen 112, and is presented with information retrieved from the knowledge base 114a indicating the reason why each is an item of textual interest. The user 102 is thereby kept appraised of known items of textual interest appearing on the screen 122, reducing the chances that that user will not notice such items as they scroll past.

An important aspect of the alerting feature is that the perform recognition component 134 detects characters from an image of the screen 112. This is done by image processing and character recognition. In some embodiments, the perform recognition component 134 may use a variation of the open-source OCR engine called “tesseract-ocr”, described at haps://code.google.com/p/tesseract-ocr/, retrieved Sep. 2, 2014.

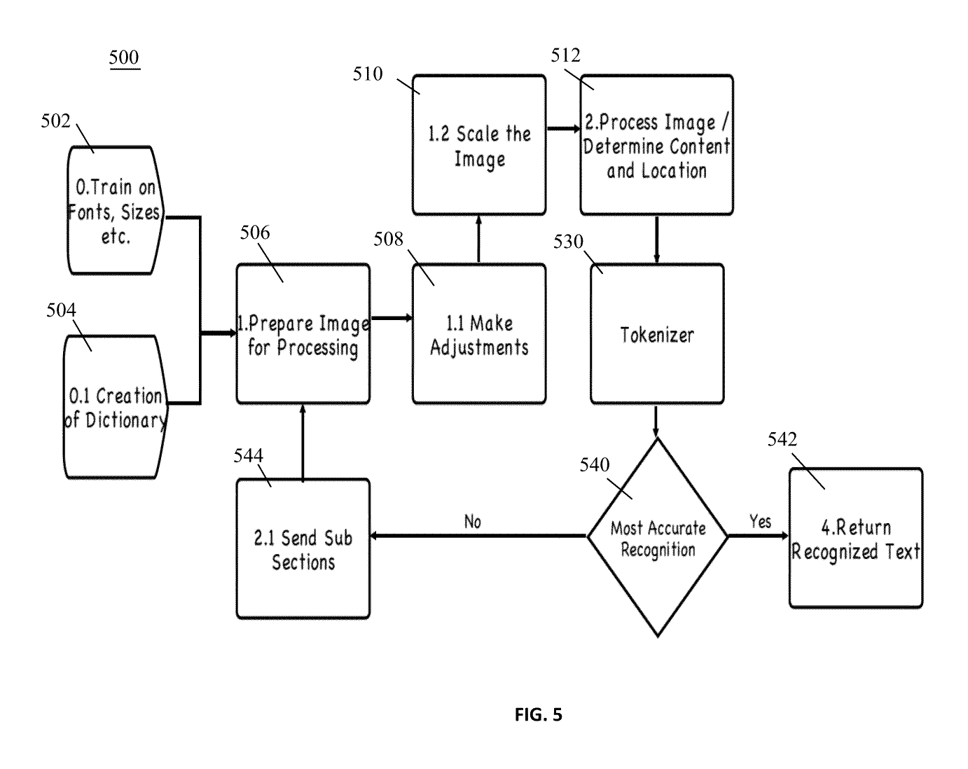

FIG. 5 shows one embodiment of a flowchart 500 explaining one embodiment of how the perform recognition component 134 and tokenizer components 136 may work together to create a record of extracted entities. Preliminary to any use, the perform recognition module 134 is configured to recognize different fonts, font sizes, etc. within a screen image. This can be done by, e.g., training on different fonts and font sizes, as depicted in step 502 and/or by other methods of establishing a dictionary which can, e.g., map pixel bitmaps onto specific characters, as depicted in step 504. When invoked, the perform recognition component 134, acting on the grabbed screen image, takes image pre-processing steps 506 (e.g., filtering, contrast enhancement) and further adjusts the image 508 (e.g., image segmentation into subsections). The perform recognition component 134 may then scale the image in step 510, before additional steps 512 are taken to perform character recognition and create a record comprising the detected characters and their locations in the image.

Then, in step 530, the tokenizer component 136 detects extracted entities. This is done by parsing the recognized textual characters by, e.g., splitting on certain non-alphanumeric characters such as commas, spaces and other delimiters, and/or by running regular expression matching.

Next, in step 540, if accuracy could be improved with additional analysis such as by processing individual subsections or making additional adjustments, send sub-sections of image back through process 500 as visualized in step 544.

Otherwise, in step 542, return recognized text and location of text on screen.

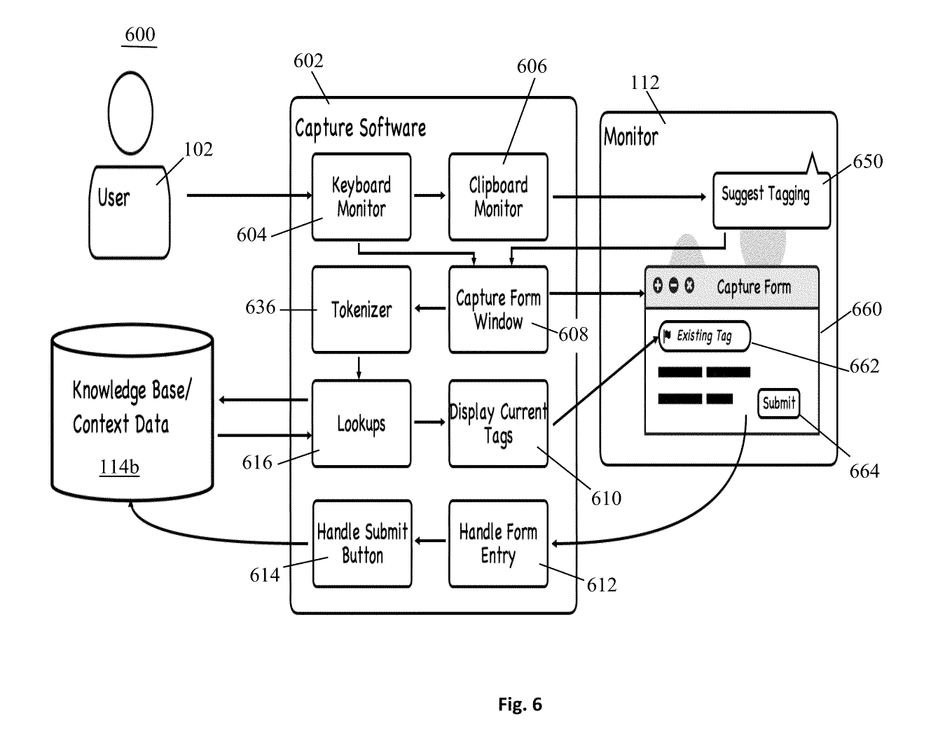

FIG. 6 shows another aspect of the subject matter of the present application. In particular, FIG. 6 shows a tagging system 600 for tagging an item appearing on the screen so that a user 102 can add the tagged item to the knowledge base 114b. Thus, the tagging function is a function that allows a user to mark a new potential item of interest (extracted entity) appearing on a screen, and open a window to facilitate tagging that item.

When the tagging function is implemented, the user 102 interacts with the computer monitor (screen) 112 while capture (tagging) software 602 runs in the background. The capture software 602 comprises a number of software components shown generally as 604-616 and tokenizer component 636.

Keyboard input is monitored by a keyboard monitor component 602 which looks for a first predetermined tagging keystroke to invoke tagging. In one embodiment, the keyboard monitor component 602 invokes the tagging function when a user selects an item (e.g., text) on the screen with a pointing device (e.g., a mouse), and then types “CTRL-C” on the keyboard, which serves as the first predetermined tagging keystroke. This both copies the selected item to a temporary memory, i.e., a clipboard (e.g., an operating system clipboard) and, as discussed below, gives the user the option of tagging the selected item.

A clipboard monitor component 606 detect that there is a new item in the clipboard and causes a suggest tagging message 650 to be displayed on the screen 112. The suggest tagging message 650 suggests to the user that the new (selected) item be tagged.

If the keyboard monitor component 602 then detects a second predetermined tagging keystroke (e.g., another CTRL-C within a predetermined period of time after the first CTRL-C) or a specific pointing device command (e.g., a click with the cursor pointer to the suggest tagging message 650), a capture form window component 608 causes a tagging window 660 to open on the screen 112, permitting the user 102 to tag the new item.

The new item is also submitted to the tokenizer component 636 which determines whether the new item comprises a new extracted entity. If so, the new extracted entity is submitted to the lookups component 616 which consults the knowledge base 114b to determine whether the new extracted entity has previously been tagged.

If the new extracted entity of interest has previously been tagged (i.e., is a known item of textual interest), the display current tags component 610 causes any tags associated with the new extracted entity (which is thereafter considered to be a known item of textual interest) to be displayed in a tag information portion 662 of the screen, which portion 662 may be part of the tagging window 660.

Regardless of whether new extracted entity has previously been tagged, the user 102 may enter tagging information for the new/existing extracted entity in the tagging window 660. Entry of this information is managed by a handle form entry component 612. Upon completion of the entry, the user 102 may activate a submit button 664, which causes a handle submit button component 614 to update the knowledge base 114b with the information entered into the tagging window 660 and received by the handled form entry component 612. This adds the new extracted entity to the knowledge base 114b where it thereafter considered a known item of textual interest for use in subsequent alerts and other functions.

It should be evident that in some scenarios, a first user during a first session adds a new known item of textual interest to the knowledge base 114b, and a second user during a second session at a later point in time is alerted to that new known item of textual interest if that item is being displayed on the second user's computer screen. In this manner, the second user can benefit from the prior tagging action of his or her colleague.

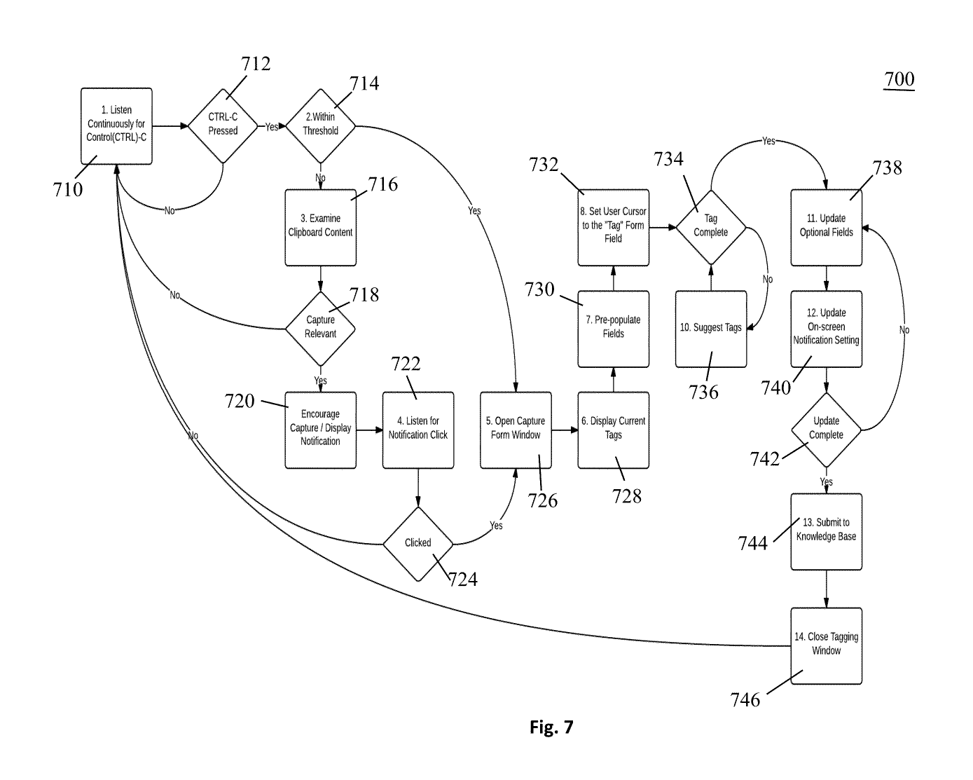

FIG. 7 presents a flowchart 700 of the tagging process.

In step 710, the keyboard monitor continuously listens for the first predetermined tagging keystroke (in this embodiment, a CTRL-C). If CTRL-C has been pressed 712, a check is then made in step 714 to determine whether CTRL-C had been pressed twice within a first predetermined time period.

If in step 714, it is determined that “CTRL-C” was pressed twice in succession within the first predetermined time period, this manifests the user's intent to tag the selected item, in which case control flows to step 726 in which a tagging window is opened.

If in step 714, it is determined that “CTRL-C” was not pressed twice in succession within the first predetermined time period, the clipboard's contents are obtained in step 716 and in step 718 the clipboard's contents are examined to determine if they contain a predetermined structure or format, which may thus qualify as a potential item of interest (e.g., an IP address) and thus may be an extracted entity.

If, in step 718 it is determined that the clipboard's contents do not contain an extracted entity, the process returns to step 710 to await another CTRL-C. If, on the other hand, in step 718 it is determined that the clipboard's contents do contain an extracted entity, control flows to step 720 where a suggest tagging message 650 is displayed on the screen 112. Then, in step 722, the keyboard monitor component 604 (see FIG. 6) checks for user input and in step 724 determines to see if the user elected to tag the item by, for example, clicking on the suggest tagging message 650. If it is determined in step 724 that the user did not elect to tag the item, control returns to step 710 where the process awaits a new “CTRL-C”. If, on the other hand, in step 724 is it determined that the user elected to tag the item, control flows to step 726 in which a tagging window is opened.

Then, in step 728, any current tag information associated with the potential item of interest is displayed. In step 730, the tagging window is pre-populated with information about the potential item of interest, such as its content, source, the time it appeared on the screen, etc.

In step 732, the cursor is moved to a field in the tagging window to facilitate entry of user-specified tagging information. In step 734 as check is made to see if the user has indicated that the tagging is complete. If not, in step 736 additional tagging is suggested and/or its entry accepted. Steps 734 and 736 are repeated until the user finally indicates that tagging is complete.

Control then flows to step 738 where the user is provided with the option of updating one or more fields in the tagging window. In step 740, the user may update on-screen alerting settings, and in step 742 a check is made to see if the user manifests that he or she is done with the tagging window (by, e.g., hitting a “submit” button). If not, control returns to step 738 for the user to continue entering information.

After it is finally determined in step 742 that the user has finished entering/updating information into the tagging window, control flows to step 744 where the system 600 updates the knowledge base 114b with the newly tagged information, which thereafter may be regarded as a known item of textual interest. Then, in step 746, the tagging window is closed and control returns to step 710 to await another CTRL-C.

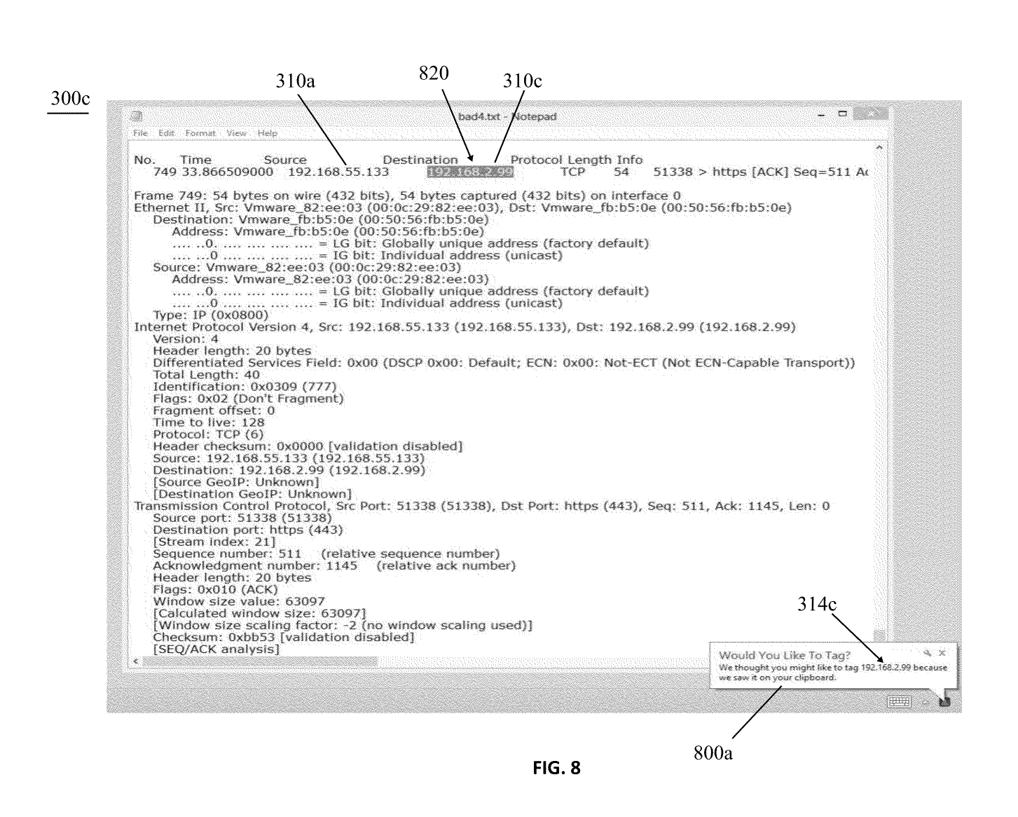

FIGS. 8-13 demonstrate certain aspects of the tagging function using screen shots from a second software application—in this instance, Notepad.

FIG. 8 shows an exemplary first Notepad screen shot 300c after the user has highlighted a window portion 820 containing the IP address “192.168.2.99” 310c (third item of interest 310c), and has entered the first predetermined tagging keystroke of “CTRL-C”. The screen shot 300c also happens to contain the first item of interest 310a (i.e., the IP address “192.168.55.133” mentioned above in connection with FIGS. 3 and 4 and the exemplary screen shots illustrating the alerting function.

In the case of screen shot 300c, by entering “CTRL-C”, the user has copied the contents of the highlighted portion 820 to the clipboard. In addition, the tagging system 600 displays a suggest tagging message 800a which offers the user the opportunity to tag a potential item of interest within the highlighted portion. In this example, the suggest tagging message 800a includes a message entry 314c comprising the IP address “192.168.2.99”. The suggest tagging message 800a reads “Would you like to Tag? We thought you might like to tag 192.168.2.99 because we saw it on your clipboard”.

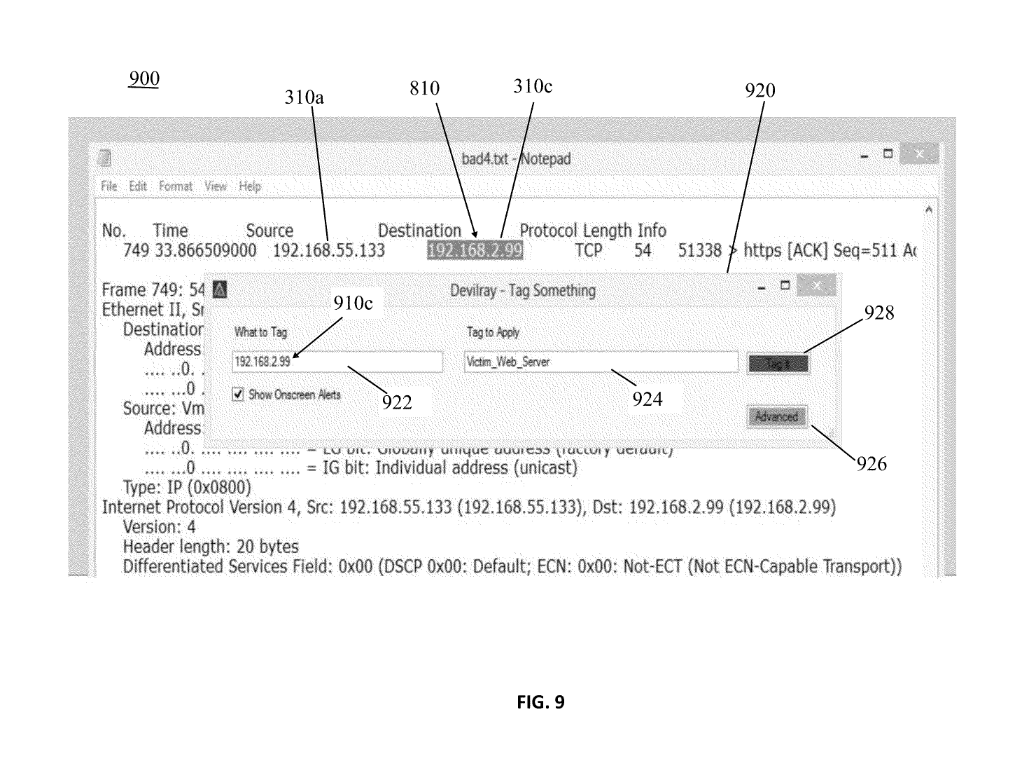

FIG. 9 shows an exemplary second Notepad screen shot 900, after the user clicking on the suggest tagging message 800a of FIG. 8, manifesting a desire to tag IP address “192.168.2.99” as a third item of interest 310c. The direct result of the user's action is the opening of a basic tagging window 920 which, in this embodiment, comprises fields 922, 924 and buttons 926, 928

Field 922 is pre-populated with candidate new IP address 910c (“192.168.2.99”), which is the soon-to-be-tagged third item of interest 310c.

Field 924 may be entered by the user (in this example, the tag reads “Victim_Web_Server”) or pre-populated with a suggested tag, the suggestion being based on text entered by the user (“auto-complete” or “similar-tags”) or heuristics associated with classifying IP addresses of interest.

“Advanced” button 926 allows the user to open an advanced tagging window while “Tag it” button 928 allows the user to indicate that tagging is complete.

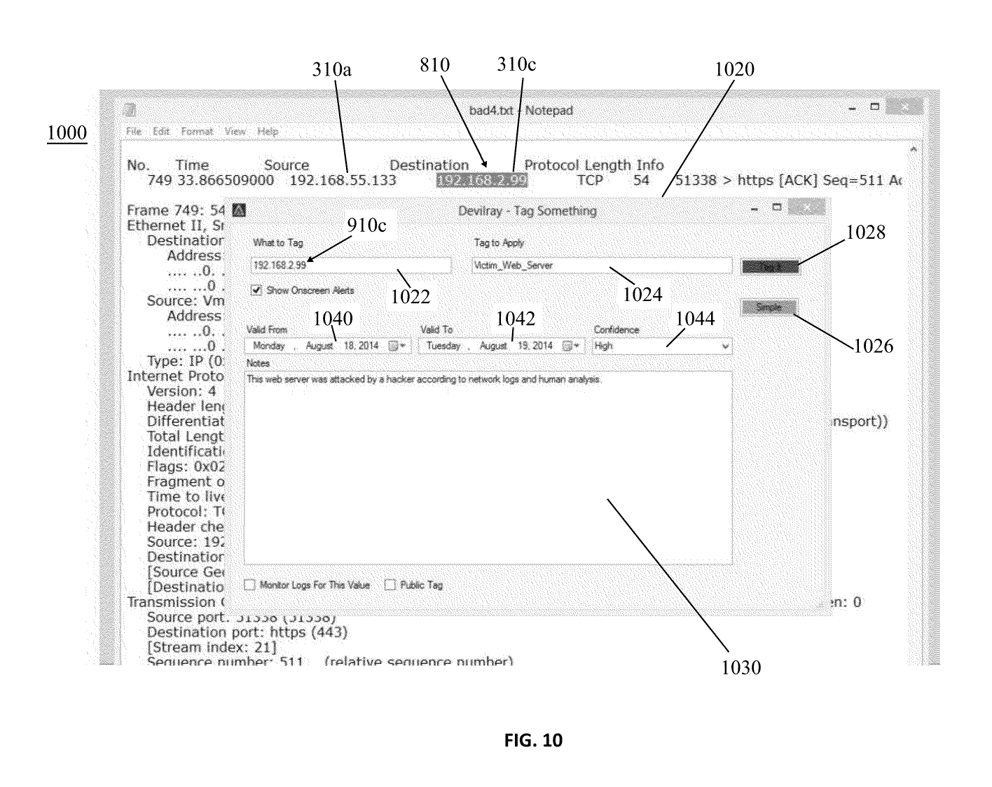

FIG. 10 shows an exemplary third Notepad screen shot 1000, after the user has clicked on the “Advanced” button 926 in the screen shot 900 of FIG. 9. The direct result of the user's action is the opening of an advanced tagging window 1020 which, in this embodiment, comprises fields 1022, 1024, 1030, 1040, 1042, 1044 and buttons 1026, 1028.

Field 1022, like field 922, is pre-populated with candidate new IP address 910c (“192.168.2.99”), which is the soon-to-be-tagged third item of interest 310c.

Field 1024, like field 924, may be entered by the user or pre-populated with a suggested tag (in this example, the tag reads “Victim_Web_Server”). Once again, the suggestion is based on text entered by the user (“auto-complete” or “similar-tags”) or heuristics associated with classifying IP addresses of interest.

Field 1030 is a comment field into which the user 102 may make any desired notes regarding the item being tagged.

Fields 1040 and 1042, in this example, are provided to store start and end dates. In one embodiment, the start and end dates delimit the period during which the item being tagged is valid and/or during which alerts should be provided if the new item being tagged is subsequently detected on a screen. Field 1044 is provided to accommodate a confidence level regarding the accuracy, threat level, or other parameter of the new item being tagged. Fields 1040, 1042 and 1044 may be pre-populated with suggestions in the form of default values and/or values based on some heuristics. Again, as is the case with field 1024, the user is free to ignore and/or override the suggestions and enter values of his or her own choosing.

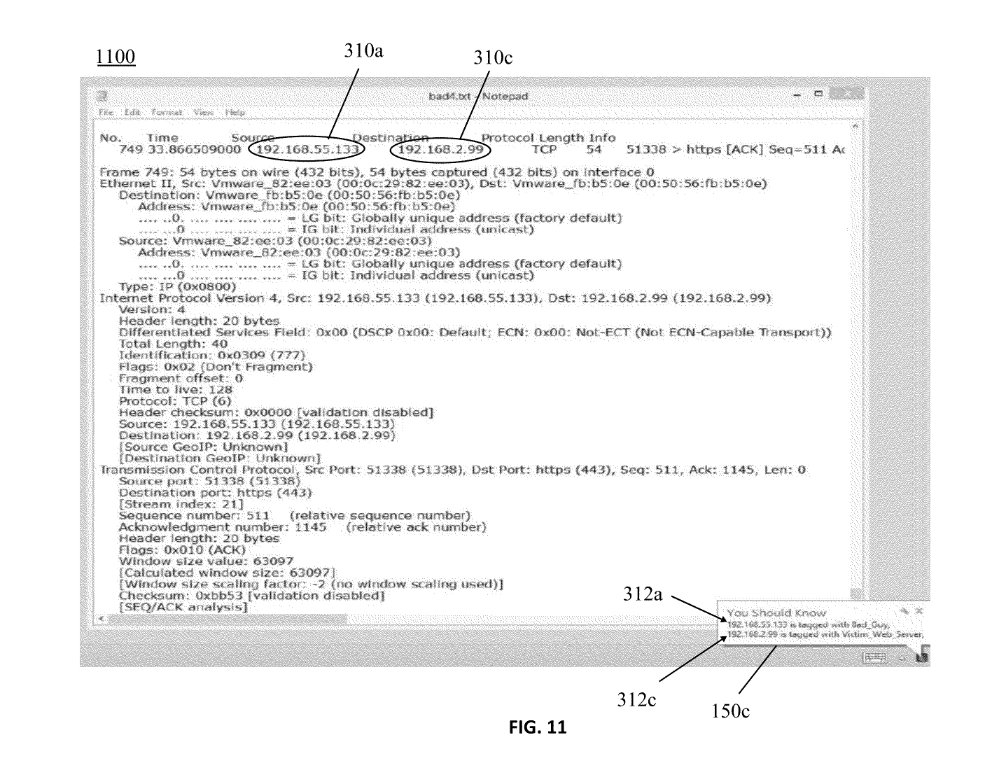

FIG. 11 shows an exemplary screen shot 1100 after the user has completed tagging the third item of interest 310c (i.e., the newly tagged IP address “192.168.2.99” seen in FIGS. 8-10), and the alerting function discussed above is in effect.

As discussed above, the tagging function enters the new item of interest—in this example IP address “192.168.2.99”—into the knowledge base 114b, where it is thereafter regarded as a known item of textual interest. Therefore, when the alerting function is in effect, it matches on-screen content against all known items of textual interest in the knowledge base 114b. And since the third item of interest is both on-screen in FIG. 11 and in the knowledge base 114b, the notification 150c in FIG. 11 lists both notification entries 312a and 312c, which correspond to the first and third items of interest 301a, 310c, respectively, i.e., IP addresses “192.168.55.133” and “192.168.2.99”, respectively.

The notification 150c in this example provides the following two pieces of information: (1) “192.168.55.133 is tagged with “Bad_Guy” (which is the same information given about this IP address in the notifications 150a, 150b seen in FIGS. 3 and 4 in connection with the “Wireshark” application); and (2) “192.168.2.99 is tagged with “Victim_Web_Server” (which is the tag ascribed to this third item of interest in the tag windows 920, 1020 seen in FIGS. 9 and 10, respectively, in connection with the Notepad application).

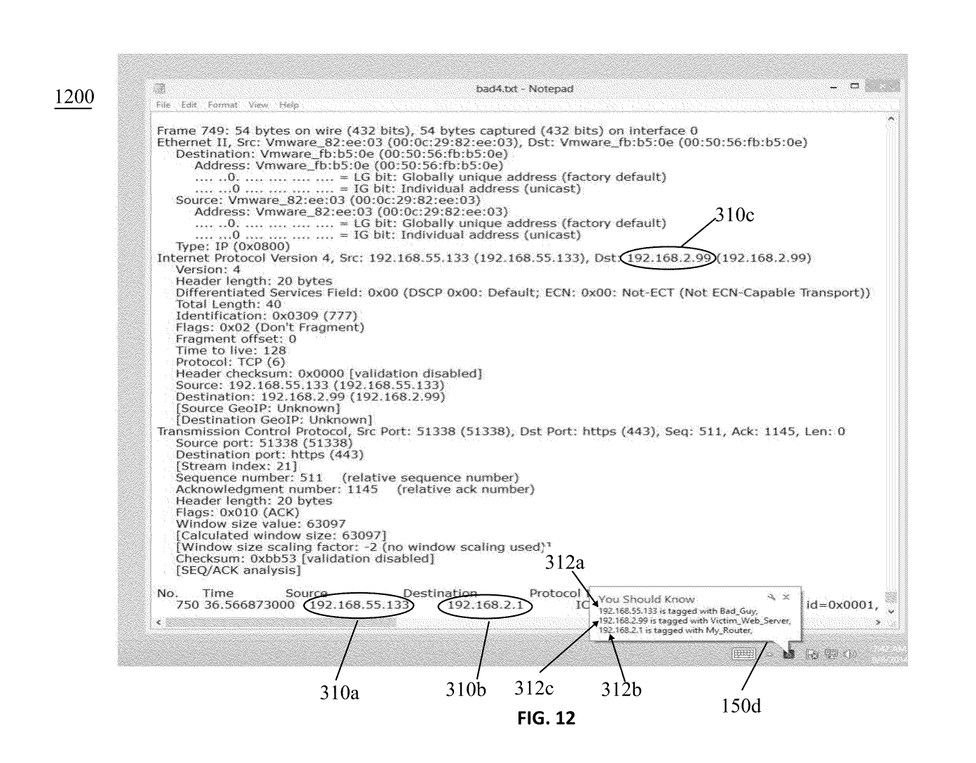

FIG. 12 shows a screenshot 300d, based on scrolling up a few lines from the screenshot 300c of FIG. 11. In the screenshot 300d of FIG. 12, the user is notified of another IP address of interest, specifically the second IP address of interest 310b mentioned found in the screenshot 300b of FIG. 4 discussed above. Thus, the notification 150d in the screenshot 300d of FIG. 12 has three notification entries 312a, 312b, 312c corresponding to the matched first, second and third IP addresses of interest, “192.168.55.133”, “192.168.2.1” and “192.168.2.99”.

It can be seen from the above discussion of FIG. 5, the perform recognition component 134 of the alerting function is based on the imaged screen, and therefore is application-independent. Thus, the alerting function works regardless of which software application displays content on the screen 112. Thus, a notification may comprise notification entries from two or more windows appearing on the screen 112, each window driven by a different software application (e.g., “Wireshark” and Notepad). This allows the user to view windows from two or more applications, or even from two processes of the same application, and keep informed of items of textual interest, without having to “switch” between the two or more windows, e.g., with a mouse. Therefore in some embodiments, the notification 150d seen in FIG. 12 may appear the same, even if the two IP addresses appeared in different window driven by different applications, so long as they appeared on the same screen.

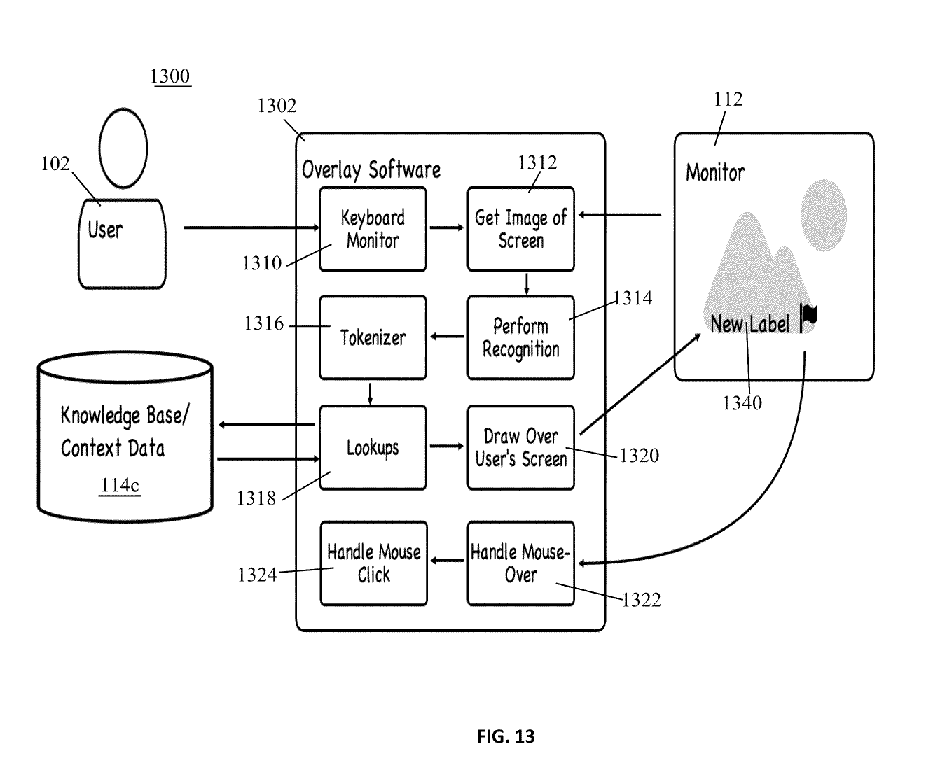

FIG. 13 shows yet another aspect of the subject matter of the present application. In particular, FIG. 13 shows an overlay system 1300 for indicating overlay items of potential interest on a computer screen 112, and/or presenting information 1340 about one or more of those items.

In some embodiments, the overlay system 1300 extracts overlay items of interest (“extracted overlay entities”) appearing on the screen 112, and indicates these on the screen by, e.g., outlining, highlighting, reverse video, or the like. In addition, a user wishing to immediately ascertain additional information about any of the indicated items may take some action, such as moving a cursor over the indicated item or clicking on the indicated item, whereupon a window open ups to present additional information. The additional information may comprise information determined “on the fly” about the indicated item, or even may comprise content from a web site associated with the indicated item. Like the alerting and tagging functions, the overlay function is independent of the underlying application (Wireshark, Notepad, a browser, etc.) displaying content on the screen 112.

In some embodiments, the additional information may include information previously stored in knowledge base 114c. In such case, the extracted overlay items of interest may be compared with known items of textual interest resident in the knowledge base 114c. Any tags or other information in the knowledge base 114c may be presented on the screen, optionally in close proximity to the extracted overlay item of interest.

The overlay system 1300 includes overlay software 1302 comprising a number of components. A keyboard monitor component 1310 detects whether the user 102 has pressed the predetermined enable overlay keystroke to enable the overlay function. In one embodiment, the predetermined enable overlay keystroke is to press ALT-CTRL-C, and the user must keep this combination pressed down to use overlay function. To turn off the overlay function, the user simply releases the combination ALT-CTRL-C which had been pressed to enable the overlay function in the first instance. It should be evident to those skilled in the art that other keystroke combinations and methodologies may be used instead.

After the overlay system is enabled, a get image screen component 1312 captures the entire image displayed on the screen 112. Then, the perform recognition component 1314, the tokenizer component 1316 and the lookups component 1318 cooperate with the knowledge base 114c, much in the same manner as the corresponding components 134, 136, 138 of the alerting system 100 of FIG. 1 cooperate with knowledge base 114a. In this manner, in some embodiments, the overlay system 1300 identifies known items of textual interest appearing on the screen 112 at any given instant, and creates a record of these. Based on the created record, a draw over user's screen component 1320 then indicates the corresponding known items of textual interest on the screen 112.

After the known items of textual interest are indicated on the screen, a handle mouse over component 1322 detects whether the user has moved the mouse in close proximity to any one of the indicated items of textual interest on the screen 112. If the mouse has been moved into close proximity to an indicated item of textual interest, a window may open and/or a message may be displayed presenting information 1340 about that indicated item. Thereafter, a handle mouse click component 1324 is configured to determine whether the user indicates that additional information pertaining to the indicated item of textual interest is to be displayed as well. The user may indicate this by a mouse click or the like on the window or message

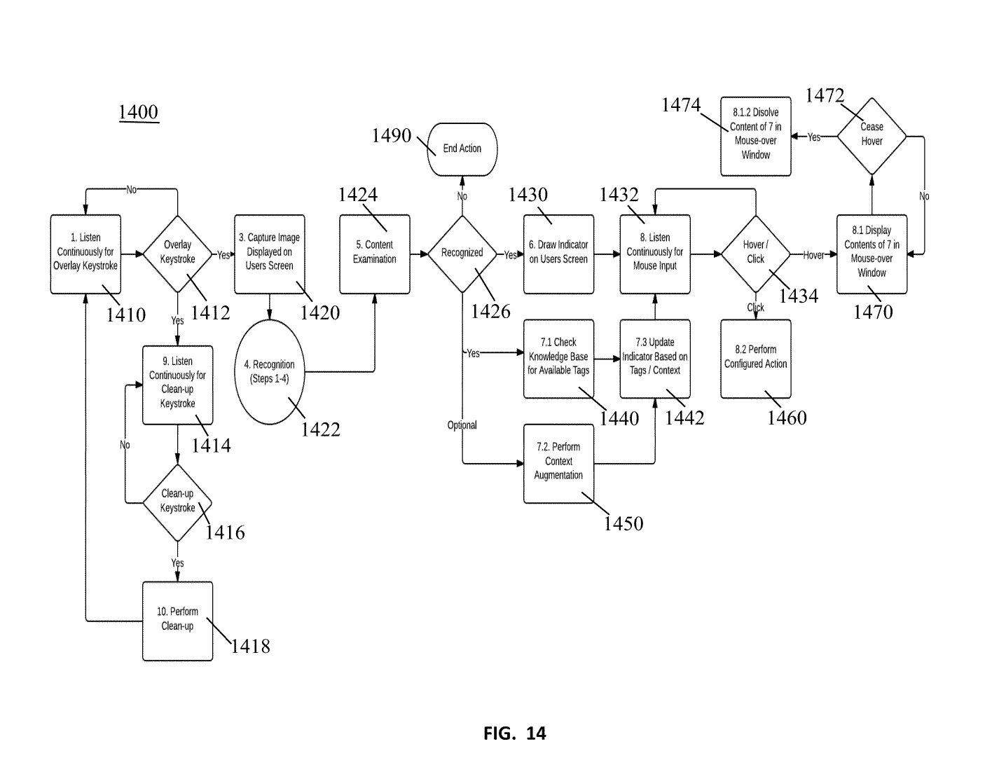

FIG. 14 presents a flowchart 1400 of the overlay process.

In step 1410, the keyboard is monitored on an ongoing basis and in step 1412 a determination is made as to whether the predetermined enable overlay keystroke has been entered. If it has not been entered, the keyboard is continued to be monitored.

If, on the other hand, it is determined in step 1412 that the predetermined enable overlay keystroke has been entered, the main overlay process and an ancillary overlay processes are initiated in parallel.

The ancillary overlay process comprises steps 1414, 1416 and 1418. In step 1414 the ancillary process listens for a predetermined clean-up keystroke. In one embodiment, the predetermined clean-up keystroke is ALT-CTR-C. If in step 1416 it is determined that the predetermined clean-up keystroke has been de-pressed, control goes to step 1418 where the screen is cleaned up, by removing all windows and messages resulting from the overlay function.

In the main overlay process, the screen image is captured in step 1420 and in step 1422 recognition is carried on the contents of the captured screen image to determine whether the overlay items of interest are present. In step 1424, the overlay items of interest are compared to the known items of textual interest in the knowledge base 114c and a record comprising the matched item is created.

If, in step 1426, it is determined that there are no matches for the overlay items of interest, the overlay process terminates at step 1490.

If, on the other hand, it is determined in step 1426 that there are one or more matches, then the process takes a plurality of actions.

The first of these actions, seen in step 1430, is to indicate the overlay items of interest appearing on the screen 112 by, providing an indicator such as a rectangular box around the text or object constituting the overlay item of interest. This instantly informs the user of the on-screen locations of the overlay items of interest.

A second of the actions, seen in step 1440 is to determine whether any tags associated with the various indicated overlay items of interest are available from the knowledge base 114c, if so indicating the overlay items of interest are actually known items of textual interest. The third action, seen in step 1450, is to determine whether any context information is available for the various indicated overlay items of interest and known items of textual interest. Context information may include things likely to be of interest to the user, such as geo-location information of an IP address, current price of a stock symbol, a web page associated with a domain name, and the like. After making the determination in steps 1440 and 1450, in step 1442 the indicator is updated by, e.g., color-coding and/or adding symbols, to indicate what types of information is available for each of the overlay items of interest and the known items of textual interest.

After these actions, in step 1432, the overlay process waits for mouse input, checking in step 1434 whether the cursor has been moved by the user in close proximity to one of the indicators, or the mouse has been clicked.

If in step 1432, the cursor is determined to hover in close proximity to a particular known item of textual interest, then in step 1470 the items determined in steps 1440 and 1450 are displayed in a window so long as the cursor hovers over the known item of textual interest in question. If the cursor no longer hovers over the known item of textual interest (step 1472) then the window closes (step 1474). If in step 1432, a mouse click is detected, then in step 1460, a predetermined action is carried out, such as opening a corresponding web page or the like. The overlay process continues to wait for additional mouse input (step 1432) regardless of which action is taken.

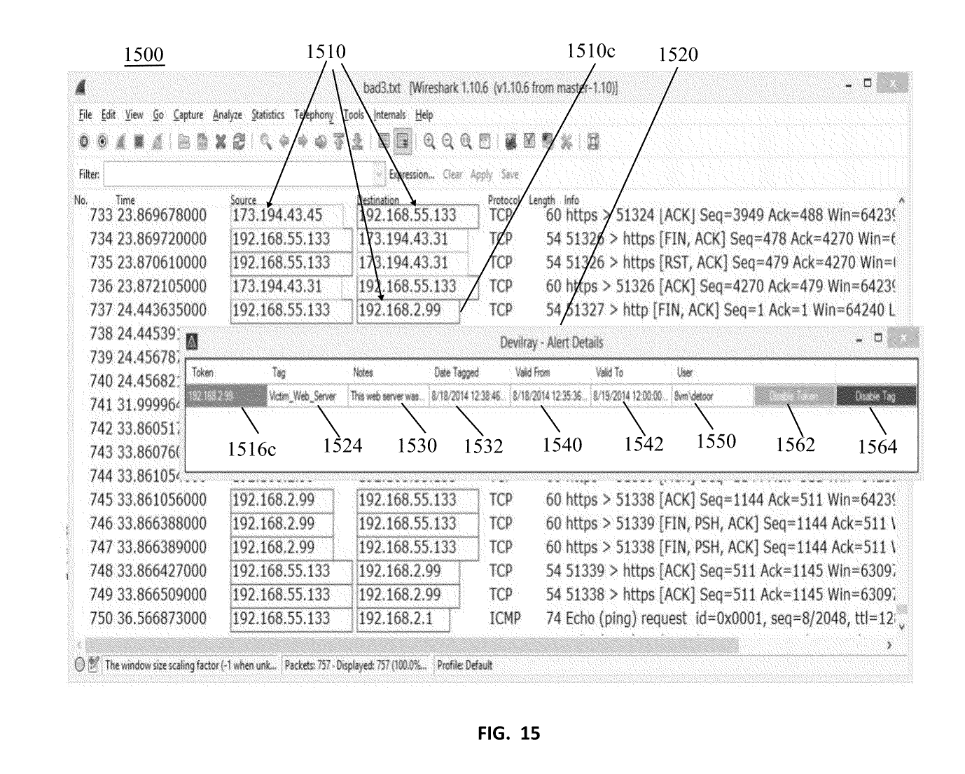

FIG. 15 shows a screenshot 1500 in which a number known items of textual interest 1510 are indicated, the indicator being a rectangle around each such known item of textual interest. FIG. 15 illustrates a first embodiment of the consequence of a user clicking on a selected indicated known item of textual interest 1510c—in this case the IP address “192.168.2.99” which corresponds to the previously mentioned third item of interest 310c. In response to clicking, the overlay process opens an overlay window 1520 comprising a number of editable fields. Included among these are an item field 1516c presenting the selected indicated known item of textual interest 1510c, a tag field 1524 displaying the tag “Victim_Web_Server” ascribed to this item, and a notes field 1530 containing notes which had been filled out during a previous tagging process. The overlay window 1520 also includes a date-tagged field 1532 containing information as to when the item 1510c was initially tagged, valid date range fields 1540, 1542 containing the beginning and end dates, respectively, over which the tag is valid, and an tag-user field 1550 identifying the user or organization that initially tagged item 1510c. The user is able to edit one or more of these fields, as desired. Any changes made to these fields are then updated in the knowledge base 114c. The overlay window 1520 also include buttons such as a “Disable Token” button 1562 and a “Disable Tag” button 1564, respectively, to modify the status of the selected known item of interest.

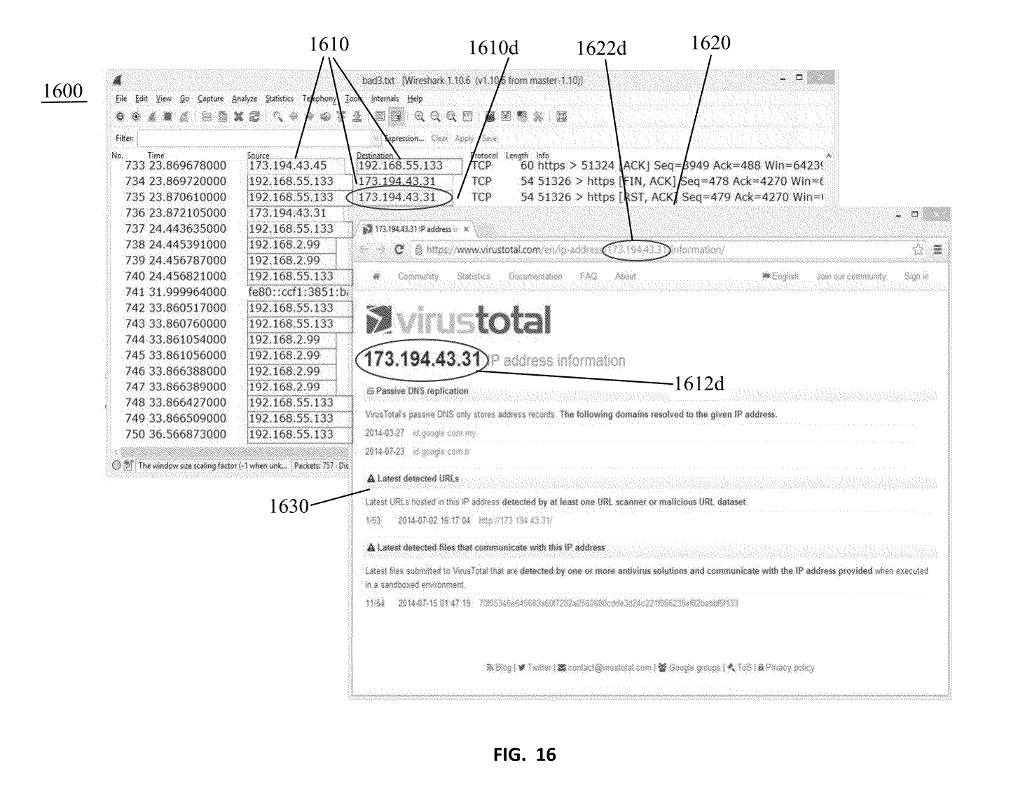

FIG. 16 shows a screenshot 1600 in which a number of known items of textual interest 1610 are again indicated, the indicator again being a rectangle around each such known item of textual interest. FIG. 16 illustrates a second of the consequence of a user clicking on a selected indicated known item of textual interest 1610d—in this case, a fourth item of interest constituting IP address “173.194.43.31”. In response to the mouse click, the overlay process opens an overlay web page 1620 displaying information about the IP address in question. In this example, the overlay web page 1620 is provided by the web site www:virustotal.com and the specific domain name (created by the overlay process itself) contains the string of characters 1622d matching the selected indicated known item of interest 1610d, thereby indexing the corresponding information from the www.virustotal.com web site. In this instance, the content 1630 of the web page includes the IP address 1612d corresponding to the selected indicated known item of textual interest 1610d, and presents information gathered by www.virustotal.com pertaining to the selected indicated known item of textual interest 1610d. It is understood that the overlay process may be configured to access other web pages, depending on the nature of the selected indicated item of interest and web sites that are accessible.

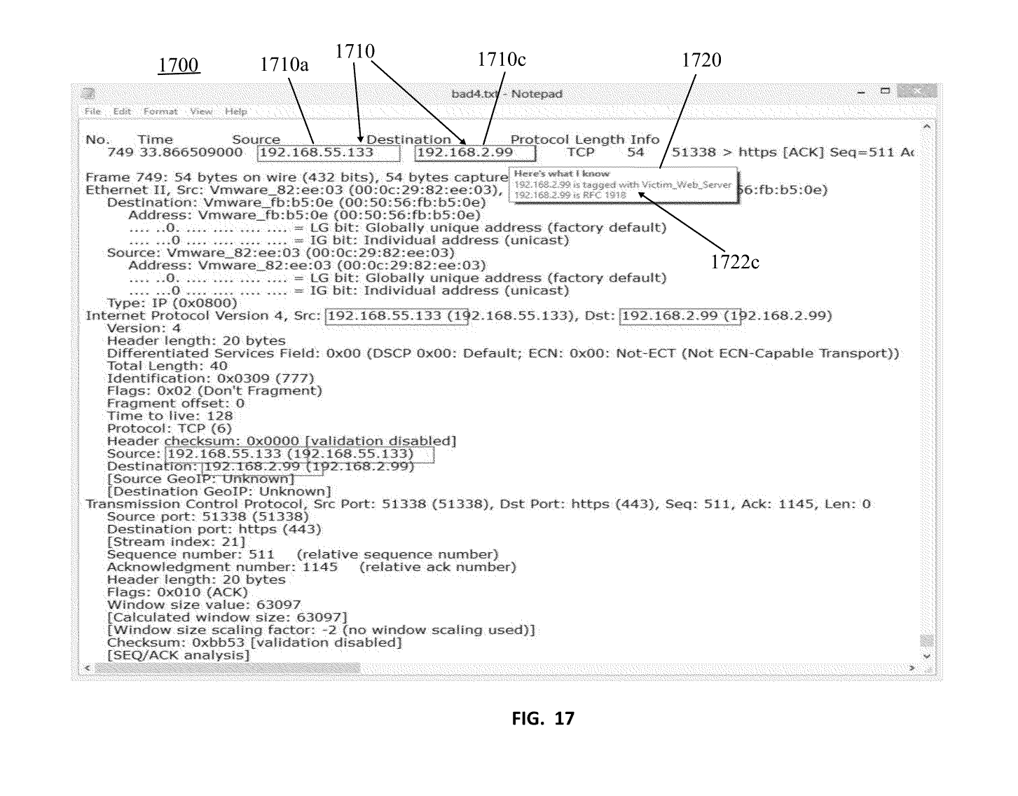

FIG. 17 shows another screenshot 1700 in which a number known items of textual interest 1710 are again indicated, the indicator again being a rectangle around each such known item of textual interest. In FIG. 17, one of the known item of textual interest 1710a constitutes the IP address “192.168.55.133” (and corresponds to the first item of interest 310a discussed above) while the one known item of textual interest 1710c constitutes the IP address “192.168.2.99” (and corresponds to the third item of interest 310c discussed above). FIG. 17 illustrates an embodiment of the consequence of a user moving the cursor so that it hovers over a selected indicated known item of textual interest, in this instance item 1710c. As seen in FIG. 17, in response to hovering, the overlay process opens an overlay hover static window 1720. However, unlike the editable overlay window 1520 which shows a number of fields which the user may edit (see FIG. 15), overlay hover static window 1720 comprises an overlay hover message 1722c presenting information known about the IP address in question and does not permit the user to edit its content. In this example, overlay hover message 1722c reads “Here is what I know—192.168.2.99 is tagged with Victim_Web_Server—192.168.2.99 is RCC 1918.”

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

Also, while the present invention has been described with reference to specific embodiments, these are not intended to limit its scope. For instance, the tagging function and the overlay function and their associated processes may exist independently of the alerting function and each other. Additionally, the present invention contemplates any combination of two of the the functions in a system or method.

What is claimed is:

1. A system configured to alert a viewer of a computer screen to an on-screen presence of a specific item of textual interest comprising a consecutive string of displayable characters having a predetermined structural format, the system comprising:
(a) an alerting function which, without viewer intervention, is configured to:
capture an image of at least a portion of the computer screen;
perform character recognition on the captured image to obtain at least one extracted entity comprising a consecutive string of displayable characters following the predetermined structural format;
compare the at least one extracted entity with a knowledge base comprising at least one known item of textual interest to find if there is a match; and
indicate on the computer screen at least one matched known item of textual interest, to thereby alert the viewer that said at least one known item of textual interest currently appears on the computer screen.

2. The system according to claim 1, wherein the alerting function displays an additional copy of the at least one known item of textual interest matched by the extracted entity along with additional information about said at least one known item of textual interest.

3. The system according to claim 1, wherein the alerting function is further configured to:
grab the entire image currently being displayed on the computer screen;
compare the entire grabbed image with a previously grabbed entire image to determine if there has been a change; and
perform character recognition only on changed portions of the image to obtain said at least one extracted entity.

4. The system according to claim 1, wherein the predetermined structural format comprises at least one from the group consisting of an IP address, an email address, a domain name, a malware hash and a file hash.

5. The system according to claim 1, wherein:
the computer screen displays content provided by at least two different underlying software applications;
the captured image comprises content provided by each of the at least two different underlying software applications; and
character recognition is performed on the captured image to obtain at least one extracted entity from content provided by each of the at least two different underlying software applications.

6. The system according to claim 1, further comprising:
(b) a tagging function invoked by a viewer after copying a portion of selected text to a temporary memory, the tagging function configured to:
open a form on the computer screen in response to viewer action, the form having at least one field;
display at least a portion of the selected text so as to be associated with the form;
receive into the field, at least one tag entered by the viewer as being associated with the at least a portion of the selected text; and
add the at least a portion of the selected text as another known item of textual interest for future comparisons by the alerting function.

7. The system according to claim 6, wherein the at least a portion of the selected text comprises said consecutive string of displayable characters having a predetermined structural format.

8. The system according to claim 6, further comprising:
(c) an overlay function which, when enabled by a viewer, is configured to:
capture an image of at least a portion of the computer screen;
perform character recognition on the captured image to obtain at least one extracted overlay entity;
indicate said at least one extracted overlay entity on the computer screen; and
in response to viewer action selecting one of such indicated extracted overlay entities, display information about the selected one of such indicated extracted overlay entities on the computer screen.

9. The system according to claim 8, wherein the overlay function is configured to display information about the selected one of such indicated extracted overlay entities at a location proximate thereto.

10. The system according to claim 8, wherein the overlay function is configured to open and display a web page associated with the selected one of such indicated extracted overlay entities.

11. The system according to claim 8, wherein the overlay function is configured to display geo-location information associated with the selected one of such indicated extracted overlay entities.

12. The system according to claim 8, wherein the overlay function is configured to:
(a) compare the extracted overlay entity with at least one known item of textual information in the knowledge base; and
(b) if there is a match, display any tags associated with said extracted overlay entity.

13. The system according to claim 1, further comprising:
(b) an overlay function which, when enabled by a viewer, is configured to:
capture an image of at least a portion of the computer screen;
perform character recognition on the captured image to obtain at least one extracted overlay entity;
indicate said at least one extracted overlay entity on the computer screen; and
in response to viewer action selecting one of such indicated extracted overlay entities, display information about the selected one of such indicated extracted overlay entities on the computer screen.

14. The system according to claim 13, wherein the overlay function is configured to display information about the selected one of such indicated extracted overlay entities at a location proximate thereto.

15. The system according to claim 13, wherein the overlay function is configured to open and display a web page associated with the selected one of such indicated extracted overlay entities.

16. The system according to claim 13, wherein the overlay function is configured to display geo-location information associated with the selected one of such indicated extracted overlay entities.

17. A method of alerting a viewer of a computer screen to an on-screen presence of a specific item of textual interest comprising a consecutive string of displayable characters having a predetermined structural format, the method comprising:
(a) capturing an image of at least a portion of the computer screen;
(b) performing character recognition on the captured image to obtain at least one extracted entity comprising a consecutive string of displayable characters following the predetermined structural format;
(c) comparing the at least one extracted entity with a knowledge base comprising at least one known item of textual interest to find if there is a match; and
(d) indicating on the computer screen at least one matched known item of textual interest, to thereby alert the viewer that said at least one known item of textual interest currently appears on the computer screen.

18. The method according to claim 17, wherein said indicating step comprises:
displaying an additional copy of the at least one known item of textual interest matched by the extracted entity along with additional information about said at least one known item of textual interest.

19. The method according to claim 17, comprising:
grabbing the entire image currently being displayed on the computer screen;
comparing the entire grabbed image with a previously grabbed entire image to determine if there has been a change; and
perform character recognition only on changed portions of the image to obtain said at least one extracted entity.

20. The method according to claim 17, wherein the predetermined structural format comprises at least one from the group consisting of an IP address, an email address, a domain name, a malware hash and a virus hash.

21. The method according to claim 17, comprising:
in said capturing step, simultaneously capturing content on the computer screen provided by at least two different underlying software applications; and
performing character recognition on the captured image to obtain at least one extracted entity from content provided by each of the at least two different underlying software applications.

22. A method of providing additional information about an item currently being displayed on a computer screen to a viewer, the method comprising:
(a) capturing an image of at least a portion of the computer screen;
(b) performing character recognition on the captured image to obtain at least one extracted overlay entity comprising a consecutive string of displayable characters following a predetermined structural format;
(c) indicating said at least one extracted overlay entity on the computer screen; and
(d) in response to viewer action selecting one of such indicated extracted overlay entities, displaying information about the selected one of such indicated extracted overlay entities on the computer screen.

23. The method according to claim 22, wherein the predetermined structural format comprises at least one from the group consisting of an IP address, an email address, a domain name, a malware hash and a file hash.

24. A method of processing information being displayed on a computer screen to a viewer, the method comprising:
(a) capturing an image of at least a portion of the computer screen;
(b) performing character recognition on the captured image to obtain at least one extracted entity comprising a consecutive string of displayable characters following a predetermined structural format;
(c) without viewer intervention:
(c1) comparing the at least one extracted entity with a knowledge base comprising at least one known item of textual interest to find if there is a match; and
(c2) indicating on the computer screen at least one matched known item of textual interest, to thereby alert the viewer that said at least one known item of textual interest currently appears on the computer screen; and
(d) in response to a viewer copying a portion of selected text to a temporary memory:
(d1) opening a form on the computer screen in response to further viewer action, the form having at least one field;
(d2) displaying at least a portion of the selected text so as to be associated with the form;
(d3) receiving into the field, at least one tag entered by the viewer as being associated with the at least a portion of the selected text; and
(d4) adding the at least a portion of the selected text as another known item of textual interest for use in a future comparing step.

25. The method according to claim 24, further comprising;
(e) when enabled by the viewer:
(e1) performing character recognition on the captured image to obtain at least one extracted overlay entity comprising said consecutive string of displayable characters following a predetermined structural format;
(e2) indicating said at least one extracted overlay entity on the computer screen; and
(e3) in response to further viewer action, selecting one of such indicated extracted overlay entities, displaying information about the selected one of such indicated extracted overlay entities on the computer screen.

26. A method of processing information being displayed on a computer screen to a viewer, the method comprising:
(a) capturing an image of at least a portion of the computer screen;
(b) performing character recognition on the captured image to obtain at least one extracted entity comprising a consecutive string of displayable characters following a predetermined structural format;
(c) without viewer intervention:
(c1) comparing the at least one extracted entity with a knowledge base comprising at least one known item of textual interest to find if there is a match; and
(c2) indicating on the computer screen at least one matched known item of textual interest, to thereby alert the viewer that said at least one known item of textual interest currently appears on the computer screen; and
(d) when enabled by the viewer:
(d1) performing character recognition on the captured image to obtain at least one extracted overlay entity comprising said consecutive string of displayable characters following a predetermined structural format;
(d2) indicating said at least one extracted overlay entity on the computer screen; and
(d3) in response to further viewer action, selecting one of such indicated extracted overlay entities, displaying information about the selected one of such indicated extracted overlay entities on the computer screen.
